(19) United States
(12) Patent Application Publication
(10) Pub. No.: US 2019/0196707 A1
(43) Pub. Date: Jun. 27, 2019

(54) USER INTERFACE FOR CROSS-DEVICE REQUESTS

(71) Applicant: NANOPORT TECHNOLOGY INC., Markham (CA)

(72) Inventors: Timothy Jing Yin SZETO, Mississauga (CA); David Michael Lopez REYES, Toronto (CA)

(21) Appl. No.: 15/840,089

(22) Filed: Dec. 13, 2017

Related U.S. Application Data
(60) Provisional application No. 62/433,716, filed on Dec. 13, 2016.
(60) Provisional application No. 62/508,142, filed on May 18, 2017.

(51) Int. Cl. G06F 3/0488; G06F 9/451; G06F 3/14; G06F 3/0481; G06F 3/0486; G06F 13/40

(52) U.S. Cl. CPC G06F 3/04883; G06F 9/451; G06F 13/4068; G06F 3/04817; G06F 3/0486; G06F 3/1446

(57) ABSTRACT

A mobile device has a touch screen and connectors located in defined locations for interconnecting with other devices. The mobile device further includes a processor and a memory storing instructions that cause the processor to: detect an interconnected device that is interconnected with the mobile device by way of a connector. The processor is further configured to determine a spatial location of the interconnected device relative to the mobile device, based on the location of the connector; define a region on the touch screen of the mobile device depending on the spatial location of the interconnected device relative to the mobile device, the region being proximate a border between the touch screen of the mobile device and the interconnected device; and transmit a request to the interconnected device if an input gesture on the touch screen of the mobile device corresponds to the region of the touch screen.

### CROSS-REFERENCE TO RELATED APPLICATIONS

This application claims the benefit of U.S. Provisional Patent Application No. 62/433,716, filed Dec. 13, 2016; and U.S. Provisional Patent Application No. 62/508,142, filed May 18, 2017.

### TECHNICAL FIELD

The following relates to mobile devices that may interact with each other and are capable of determining spatial relationships to interconnected devices, and methods.

### BACKGROUND

Mobile computing devices (e.g., mobile phones, tablets, laptop computers, etc.) are usually provided with a plurality of connection options which allow the devices to communicate with other devices electronically, or to receive or supply energy to the other devices (including obtaining energy from a power supply), or to add functionality to the devices, such as to connect the device to a peripheral device (e.g., a keyboard, a mouse, speakers, etc.).

Generally, spatial awareness is the ability (e.g., for a device) to be spatially aware and have knowledge of one or more spatial features (e.g., location, orientation, etc.) of other devices in relation to the device. Methods for assessing spatial awareness may also consider the spatial relationships between physical user interfaces, for example touch displays, of and between interconnected devices.

Conventional devices may allow for conventional cross-device interaction—often resulting from pairing the devices. For example, devices may be paired to each other using Bluetooth or other protocols. Yet other devices provide access to physically interconnected peripherals or computing devices.

However, traditional solutions for communication with interconnected devices are not concerned with the relative spatial locations of the devices or the relative spatial locations of the respective devices' user interfaces when communicating between interconnected devices.

Accordingly, there is a need for new methods and/or devices that can detect spatial relationships between connected mobile devices, and using knowledge of the spatial relationships, define a user interface that allows for communication between the interconnected devices.

### SUMMARY

According to an aspect, there is provided a mobile device comprising: a processor; a touch screen; a plurality of connectors each for interconnecting the mobile device with at least one of a plurality of other devices, each of the plurality of connectors located in a defined location on the mobile device and configured to provide an indication detectable by the processor of when a connection to one of the other devices is made or lost; and a memory storing processor executable instructions that when executed cause the processor to: detect an interconnected device that is interconnected with the mobile device by way of at least one of the plurality of connectors; establish a communication channel between the mobile device and the interconnected device; determine a spatial location of the interconnected device relative to the mobile device, based on at least the defined location of the at least one of the plurality of connectors; define a region on the touch screen of the mobile device in dependence upon the spatial location of the interconnected device, wherein the region is proximate a border between the touch screen of the mobile device and the interconnected device; receive an input gesture on the touch screen of the mobile device; and transmit a request to the interconnected device by way of the communication channel if a location of the input gesture corresponds at least in part to a location of the region on the touch screen.

According to another aspect, there is provided a computer-implemented method of defining a region of a user interface for transmitting cross-device requests at a mobile device that comprises a processor, the user interface, and a plurality of connectors each for interconnecting the mobile device with at least one of a plurality of other devices, each of the plurality of connectors at a defined location on the mobile device and configured to provide an indication detectable by the processor of when a connection to one of the other devices is made or lost, said method comprising: detecting, by the processor, an interconnected device that is interconnected with the mobile device by way of at least one of the plurality of connectors; establishing, by the processor, a communication channel between the mobile device and the interconnected device; determining, by the processor, a spatial location of the interconnected device relative to the mobile device, based on at least the defined location of the at least one of the plurality of connectors; defining, by the processor, the region on the user interface of the mobile device in dependence upon the spatial location of the interconnected device, wherein the region is proximate a border between the touch screen of the mobile device and the interconnected device; and transmitting, by the processor, a request to the interconnected device by way of the communication channel upon receiving an input gesture at a location corresponding at least in part to a location of the region on the touch screen.

Other features will become apparent from the drawings in conjunction with the following description.

### BRIEF DESCRIPTION OF THE DRAWINGS

In the figures which illustrate example embodiments,

FIG. 1 is a schematic block diagram of a pair of interconnected mobile computing devices located in proximity to one another that communicate with one another based on a user interaction related to a defined region of the devices, according to an embodiment;

FIG. 2 is a block diagram of example hardware components of a first mobile computing device of FIG. 1, according to an embodiment;

FIG. 3 is a block diagram of example software components in the first mobile computing device of FIG. 1, according to an embodiment;

FIG. 4 depicts a data store at the first mobile computing device of FIG. 1, according to an embodiment;

FIG. 5 is a flow chart illustrating definition of a region of a user interface for communicating cross-device requests, at a device initiating such a request, according to an embodiment;

FIG. 6 illustrates an example of a data structure indicating a request to be transferred from a first mobile computing device to a second mobile computing device, according to an embodiment;

FIG. 7 is a flow chart illustrating processing of cross-device requests received at a device responding to a request initiated at another device, according to an embodiment;

FIG. 8A is a schematic block diagram of the pair of interconnected mobile computing devices of FIG. 1, generating a requested action, according to an embodiment;

FIG. 8B is a schematic block diagram of the pair of interconnected mobile computing devices of FIG. 8A, illustrating the result of a responding device performing a requested action; and

FIG. 9 is a schematic block diagram of a pair of interconnected devices generating a requested action, according to an embodiment.

### DETAILED DESCRIPTION

For convenience, like reference numerals in the description refer to like elements in the drawings.

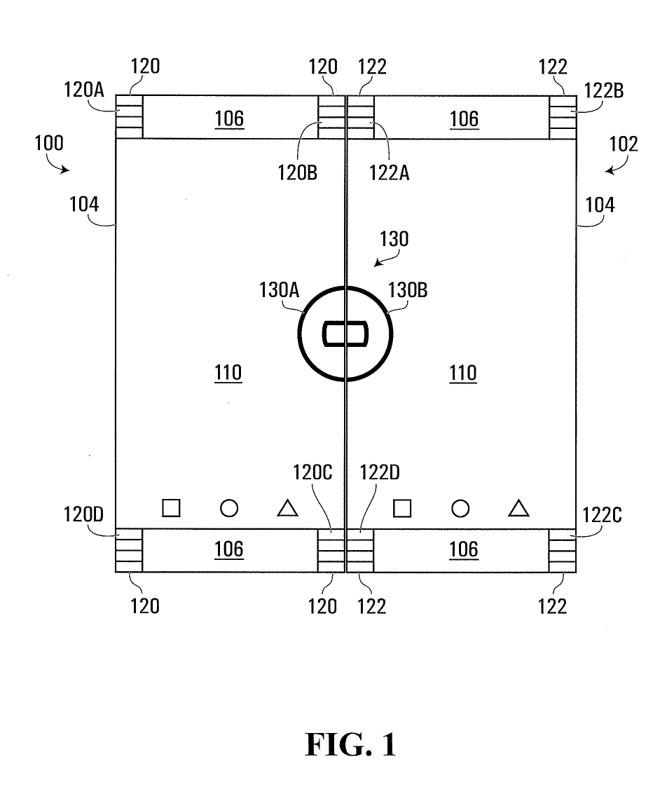

FIG. 1 depicts two devices 100 and 102, each including a housing 104 defined by respective external surfaces 106. Devices 100, 102 can be any suitable electronic devices that interface with one another to provide complementary functions as described herein. At least one of the devices 100, 102 may be a mobile computing device. For clarity in the discussion below, mobile computing devices are commonly referred to as “mobile devices” or “devices” for brevity. Each one of devices 100, 102 may be an “initiating device” and/or a “responding device”, as further detailed below.

Example mobile devices include without limitation, cellular phones, cellular smart-phones, wireless organizers, pagers, personal digital assistants, computers, laptops, handheld wireless communication devices, wirelessly enabled notebook computers, portable gaming devices, tablet computers, or any other portable electronic device with processing and communication capabilities. In at least some embodiments, mobile devices as referred to herein can also include without limitation, peripheral devices such as displays, printers, touchscreens, projectors, digital watches, cameras, digital scanners and other types of auxiliary devices that may communicate with another computing device.

In one example, each of devices 100, 102 may be a smartphone, or one may be a smartphone and the other a peripheral device (e.g., a speaker, a keyboard, a display screen, a camera). In another example, one device may be a touchscreen enabled device and the other a type of communication device (e.g., a router) for connecting to other devices. As will be apparent, other types of computing devices 100 and 102 can be envisaged that benefit from interconnection and interoperability.

Further, in some embodiments, for example as depicted in FIG. 1, devices 100 and 102 may be of the same type—generally identical in structure and components. In other embodiments exemplified below, device 100 (or a similar device) may communicate with other different yet compatible devices, in a manner exemplified herein.

Each of devices 100, 102 may have a coordinate system associated with the device. For example, a rectangular device may have a width and a length, the dimensions of which can be expressed in millimetres. Using a rectangular system of coordinates, and defining an origin at a point, (e.g., the bottom-left corner of the device), various points on the device may be represented by a coordinate defined by values along an x-axis and y-axis, for example, in millimetres, extending from the origin. As would be understood by a person skilled in the art, other two-dimensional coordinate systems may be used instead of a rectangular coordinate system, for example, a polar coordinate system, and other units of distance, for example centimetres, to define points on a device.

In the discussion below, in reference to a rectangular coordinate system originating at the bottom-left corner of a device, movement may be characterized as “rightward” along the x-axis, and “upward” or “vertically” along the y-axis, akin to the layout shown, for example, in FIG. 1.

Devices 100, 102 of other geometrical shapes, for example, generally rectangular with rounded corners, oval, or rounded in shape, may be contemplated by a person skilled in the art.

Each of devices 100, 102 may include a user interface or input interface such as a touch display 110 that cooperates with another complementary touch display 110 when the spatial locations of devices is established relative to one another (e.g., to provide one larger touch screen).

Touch display 110 may, for example, be a capacitive display screen that includes a touch sensing surface. These may be integrated as a single component. Alternatively, touch display 110 may include suitably arranged separate display and touch components. Touch display 110 may be adapted for sensing a single touch, or alternatively, multiple touches simultaneously. Touch display 110 may sense touch by, for example, fingers, a stylus, or the like. Touch display 110 may return the coordinates of any touch or touches for use by a process or device 100 or 102. Likewise, touch display 110 may be used to display pixelated graphics—in the form of computer rendered graphics, video and the like.

In an example embodiment, a larger interconnected screen allows input to be received on either one of touch display 110 of devices 100 and 102.

Touch display 110 may be defined at particular coordinates within the coordinate system of either of devices 100, 102. For example, a bottom-left corner of display 110 on device 100 may be designated at (x,y) coordinates on device 100 of (1 mm,5 mm), namely, the bottom-left corner of display 110 is offset 1 mm to the right and 5 mm above the bottom-left corner of device 100.

Each touch display 110 may have its own associated coordinate system, using the visual display of display 110 and its pixels as a frame of reference. For example, a display may have a width and a length, the dimensions of which can be expressed in pixels. Using a rectangular system of coordinates, and defining an origin at a point, (e.g., the bottom-left corner of the display), various points on the display may be represented by a coordinate defined by values along an x-axis and y-axis, for example, in pixels, extending from the origin. As would be understood by a person skilled in the art, other two-dimensional coordinate systems may be used instead of a rectangular coordinate system, for example, a polar coordinate system, and other units, for example in distance such as millimetres, to define points on a display.

As exemplified in the rectangular displays 110 illustrated, for example, in FIG. 1, each display 110 has edge boundaries at the boundaries of the coordinate system.

In the discussion below, in reference to a rectangular coordinate system originating at the bottom-left corner of a display, movement may be characterized as “rightward” along the x-axis, and “upward” or “vertically” along the y-axis, akin to the layout shown, for example, in FIG. 1.

Each of mobile devices 100 and 102 includes respective connectors 120 and 122 for allowing interconnection of devices 100 and 102. In the example illustrated in FIG. 1, device 100 includes four connectors 120A, 120B, 120C, 120D (individually and collectively connector(s) 120) and device 102 includes four connectors 122A, 122B, 122C, 122D (individually and collectively connector(s) 122). Each of the connectors 120, 122 may be located in a defined location on devices 100, 102, respectively.

Connectors 120 and connectors 122 may for example be physical connectors to a serial communications port, such as a universal serial bus (USB) port, or the like. In a particular embodiment, connectors 120 and 122 may be magnetic connectors, as detailed in PCT Publication No. WO 2015/070321, the contents of which are hereby incorporated by reference. Connectors 120, 122 may provide an electrical connection between devices 100, 102.

Although connectors 120 and 122 have been shown at the corners of each edge of devices 100 and 102, other locations of connectors 120 and 122 may be envisaged. For example, connectors on each of devices 100 and 102 can be located at the centre of the top, bottom, left and right edges of the devices, as for example illustrated in U.S. patent application Ser. No. 15/013,750, the contents of which are hereby incorporated by reference. Additionally, although four connectors have been shown, the number of connectors provided on devices 100 and 102 may vary from device to device, and may depend on the type of device 100, 102.

Devices 100 and 102 shown in FIG. 1 have been illustrated with particular exemplary connector and device form factor and geometry. Of course, alternate configurations, layout, and positioning for the connectors and alternate size and layout of the devices are possible. Similarly, although two interconnected devices 100, 102 are shown in FIG. 1, multiple (e.g., three or more) interconnected devices can be envisaged having alternate connector configurations, layout, and position and alternate size and layout of device 100. Example devices having different geometries are for example illustrated in U.S. patent application Ser. No. 15/013,750.

As disclosed in U.S. patent application Ser. No. 15/013,750, device 100 may maintain connectivity information for each of its connectors 120 in a data store, that may exist in memory as discussed in further detail below, and that may be used to determine the spatial relationship of devices (e.g., device 102) that are interconnected (e.g., mechanically and/or electrically and/or wirelessly) to device 100.

The connectivity information for mobile device 100 can include information about whether a connection exists for each physical connector 120 on mobile device 100 with another device (e.g., device 102), and/or the defined relative physical location of each of connectors 120 on device 100 (e.g., x, y parameters relative to the device, general location descriptors such as top, bottom, left, right).

Based on knowledge of the location of connectors 120, the relative spatial location of device 102 may be deduced. For example, interconnection with connector 120B may allow deduction that device 102 is connected to the right of device 100. Additionally, this connectivity information may optionally be augmented with more specific information about interconnected devices (e.g., size of any interconnected device, type of device, device identification information, physical location of connectors on an interconnected device, and devices interconnected with an interconnected device, etc.). Furthermore, knowledge of the location of components such as user interfaces on devices 100, 102 may be used to deduce the relative spatial locations of the user interfaces, for example, touch displays 110 of devices 100, 102.

In the example of FIG. 1, connectors 120B and 122A, as well as 120C and 122D are physically (e.g., mechanically) connected to one another in a side by side arrangement. In addition to the physical/mechanical connection, devices 100 and 102 are in data communication with one another.

Such data communication may occur through a communication channel established through electrical conduction of signals between electrical contacts of the respective interconnected connectors (e.g., connectors 120B and 122A and/or connectors 120C and 122D). This type of connection may be provided as a USB compatible bus established through the interconnected device connectors (e.g., connectors 120B and 122A). Alternatively, data communication may be made through a suitable wireless interfaces at devices 100, 102—for example established as a result of the proximity of device 100 to device 102. Possible wireless interfaces include WiFi interfaces; Bluetooth interfaces; NFC interfaces; and the like. Extremely high frequency (EHF) communication is also contemplated. An example of such EHF communications is described in http://keyssa.com and U.S. Patent Publication No. 2015/0065069, both of which are hereby incorporated by reference in their entirety. Other forms of wireless interfaces/communication will be appreciated to those of ordinary skill in the art.

Once a mechanical/physical connection is established between respective connectors (e.g., connectors 120B, 122A), devices 100, 102 can sense the physical interconnection (e.g., directly via the connectors and/or with external sensors), as for example disclosed in International PCT Application No. PCT/CA2017/050055, the contents of which are hereby incorporated by reference. In embodiments in which connectors 120, 122 provide mechanical connection and data connectivity, a change in the electrical characteristics at the electrical contacts of the respective interconnected connectors (e.g., connectors 120B and 122A) such as but not limited to: a change in voltage, impedance, etc., can be used to indicate a physical coupling of the respective connectors (e.g., connectors 120B and 122A).

In other embodiments, devices 100, 102 may communicate using extremely short range wireless communication, and devices 100, 102 can detect an EHF signal (e.g., received from an interconnected device 102 at device 100) which can be used to indicate that the electronic connector elements (e.g., as contained within connectors 120B, 122A) are located within a few millimetres of one another.

In some embodiments, connectors 120 and 122 include magnets utilized to physically connect devices 100 and 102 both mechanically and electrically (as discussed in PCT Publication No. WO 2015/070321). In other embodiments, at least some of connectors 120 may be adapted to physically mate with particular ones of respective connectors 122 such that when mated, connectors 120 and 122 allow interconnected devices 100 and 102 to connect both mechanically and/or electrically. In this embodiment, connectors 120 may optionally allow device 100 to transfer or receive power and/or data to or from interconnected devices such as device 102.

In some embodiments, sensors (e.g., Hall Effect sensors) on devices 100, 102 can be used to detect a magnetic field of one or more magnets in a proximate connector 120, 122. Such sensors may be integrated within each of connectors 120, 122 or provided as a separate external component. Other mechanical sensors may alternatively be used. For example, if a connector (e.g., connector 120B) includes a moveable magnetic element, a pressure sensor (not shown) can be used to detect attractive force of another connector (e.g., connector 122A) on that element and thereby detect a mechanical connection of the connectors 120B and 122A, as for example disclosed in International PCT Application No. PCT/CA2017/050055.

An indication of the physical/mechanical connectivity of devices 100 and 102 by way of one or more connectors 120, 122 can trigger a first device 100 to determine the relative spatial location of an interconnected device 102 relative to the first device 100, as for example detailed in U.S. patent application Ser. No. 15/013,750. Likewise, device 102 may perform a similar method, and also determine its relative spatial location of interconnected device 100. As noted above, such relative spatial location information may be stored in a data store.

As shown in FIG. 1, touch display 110 on device 100 may comprise an activation region 130A, and touch display 110 on device 102 may comprise an activation region 130B, collectively an activation region 130. Activation region 130 may be defined at a position within the coordinate system of display 110 and operable as described below.

Defined activation region 130 may be visually indicated by visual attributes on the visual display portion of display 110 of one or more of devices 100, 102. For example, activation region 130 may be visually indicated by a defined colour on display 110, such as a contrasting colour to other components of display 110. In some embodiments, visual attributes of activation region 130 may take the form of a visual indication, for example, an image, representing a region that straddles a contact point between devices 100, 102, such as the touching edges of devices 100, 102, for example as shown in FIG. 1. The visual indicator may, for example, be displayed such that activation region 130 is vertically centred along the touching edges between devices 100, 102. In such a manner, defined activation region 130 may indicate, visually or otherwise, the physical location of an interconnected device that a mobile device may communicate with.

In some embodiments, activation region 130 may be separated from the remainder of display 110 by a boundary, and the boundary may be visually indicated on display 110, for example, by a boundary line.

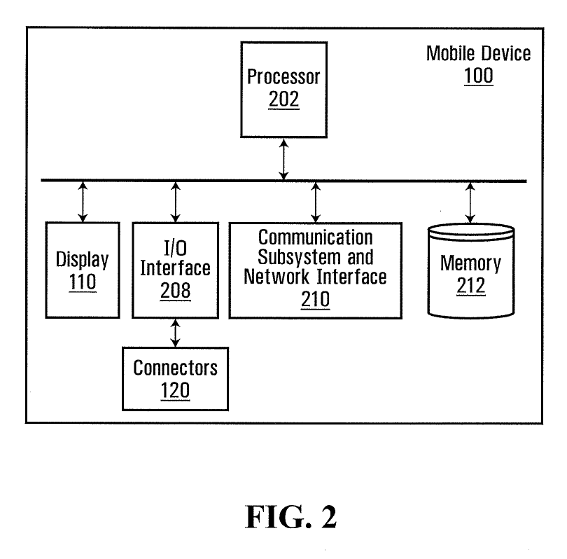

FIG. 2 is a simplified block diagram of a mobile device 100 (an example mobile computing device), according to an example embodiment. Mobile device 100 includes a processor 202, display 110, an I/O interface 208, connectors 120, a communication subsystem and network interface 210 which allows communication to external devices (e.g., interconnected devices such as device 102), and a memory 212.

Processor 202 controls the overall operation of mobile device 100. Communication functions, including data and voice communications, are performed through communication subsystem and network interface 210. Communication subsystem and network interface 210 enables device 100 to communicate with other devices (e.g., device 102). In some embodiments, device 100 may communicate with device 102 via connectors 120 by way of a bus or point to point communications (as shown in FIG. 2). Additionally, device 100 may further communicate with device 102 via communication subsystem and network interface 210.

In other embodiments, connectors 120 provide a mechanical/physical connection and the data connection between devices 100 and 102 is established instead via the communication subsystem and network interface 210 (e.g., using wireless communications such as WiFi, Bluetooth, Wireless USB, capacitive coupling communications). In such embodiments, connectors 120 may not be connected to I/O interface 208. In addition to establishing data communication between devices 100, 102 and communicating regarding whether device 100 is interconnected to device 102, wireless data communication can also be used to share connectivity information (e.g., for establishing data communications) prior to any mechanical connections being made.

In one example, device 100 may utilize connectors 120 and communication subsystem 210 to receive messages from and send messages to interconnected devices (e.g., request and receive additional spatial information from interconnected devices, such as from device 102). Accordingly, in one embodiment, device 100 can communicate with other interconnected devices using a USB or other direct connection, as may be established through connectors 120, 122. In another embodiment, device 100 communicates with interconnected devices (e.g., device 102) using Bluetooth, NFC, or other types of wireless communications as envisaged by a person skilled in the art.

Memory 212 may include a suitable combination of any type of electronic memory that is located either internally or externally such as, for example, flash memory, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), or the like.

I/O interface 208 enables device 100 to communicate via connectors 120, for e.g., to exchange data and establish communication with other devices 102. I/O interface 208 may also enable device 100 to interconnect with various input and output peripheral devices. As such, device 100 may include one or more input devices, such as a keyboard, mouse, camera, touch screen (e.g., display 110), a microphone, and may also include one or more output devices such as a display screen (e.g., display 110) and a speaker.

Device 100 may be adapted to operate in concert with one or more interconnected devices (e.g., device 102). In particular, device 100 includes an operating system and software components, which are described in more detail below. Device 100 may store the operating system and software code in memory 212 and execute that software code at processor 202 to adapt it to operate in concert with one or more interconnected devices (e.g., device 102). The software code may be implemented in a high level procedural or object oriented programming or scripting language, or a combination thereof. The software code may also be implemented in assembly or machine language.

As exemplified in PCT Publication No. WO 2015/070321, device 100 and interconnected device (e.g., device 102) may each store software code which when executed, provides a coordinator at each of devices 100, 102 which performs various functions, including detection and registration of devices connected to each of devices 100, 102. Additionally, coordinator of each device 100, 102 may coordinate task sharing between devices and task assignment from one device (e.g., device 100) to another (e.g., device 102). The coordinator may also coordinate data transfer between the devices 100, 102. Thus, a coordinator at a first device 100 can communicate with a coordinator at other devices (e.g., device 102) by way of a bus or a network or both (not shown). By way of these communications, the respective coordinators of devices 100, 102 may establish peer-to-peer relationship or a master-slave relationship, depending on the nature of the desired communication as may be established between device 100 and/or interconnected devices 102.

Those skilled in the art will appreciate that portions of an operating system, for example operating system 300 described below, and remaining software components, such as specific device applications, or parts thereof, may be temporarily loaded into a volatile store forming part of memory 212. Memory 212 or a portion thereof may be on processor 202. Other software components can also be included, as is well known to those skilled in the art.

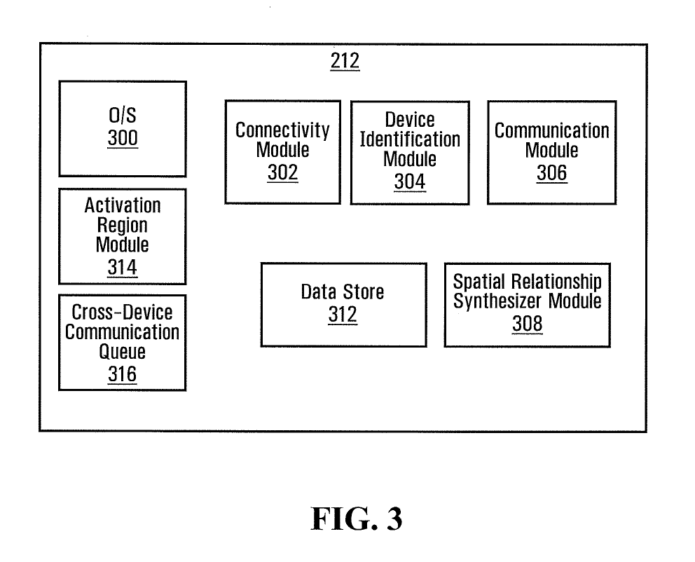

FIG. 3 illustrates an organizational block diagram of software components at device 100/102 as stored within the memory of FIG. 2 for allowing detection of spatial relationships of other interconnected mobile devices (e.g., device 102). As illustrated, software components include an operating system 300, connectivity module 302, a device identification module 304, a communication module 306, a spatial relationship synthesizer module 308, a data store 312, an activation region module 314 and a cross-device communication queue 316. Data store 312 includes information related to one or more of: connectivity, device and connector information for device 100. The operating system and components may be loaded from persistent computer readable memory onto device 100/102.

Operating system 300 may allow basic communication and application operations related to the mobile device. Generally, operating system 300 is responsible for determining the functions and features available at device 100, such as keyboards, touch screen, synchronization with applications, email, text messaging and other communication features as will be envisaged by a person skilled in the art. In an embodiment, operating system 300 may be Android™ operating system software, Linux operating system software, BSD derivative operating system software, or any other suitable operating system software.

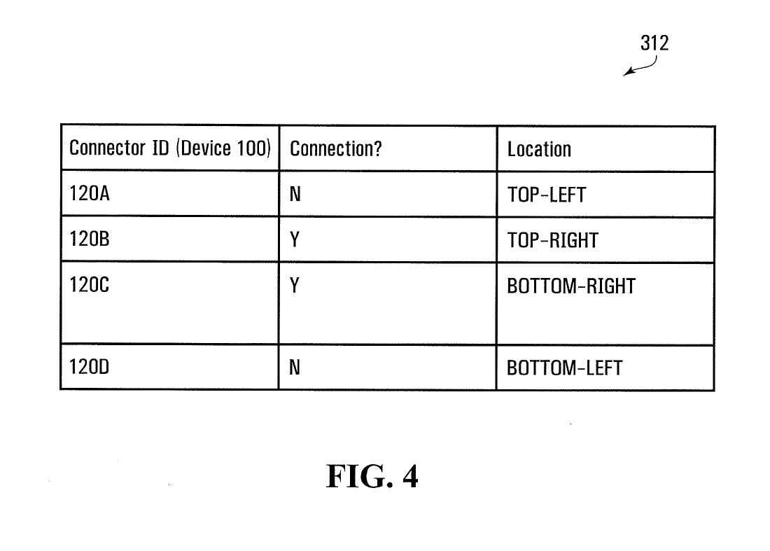

Connectivity module 302 operates in conjunction with connectors 120, and coordinates detection of when a connection is made or lost at each of the connectors 120 on device 100. Connectivity module 302 further maintains data store 312 which includes connectivity information that indicates whether a connection exists for each of the connectors 120 on the mobile device 100. Data store 312 may have any suitable format within memory 212. Further, in response to sensing that a new connection has been made or lost with a particular connector 120, connectivity module 302 updates the connectivity information in data store 312. Examples of such connectivity information are shown within data store 312 in FIG. 4.

Device identification module 304 causes processor 202 to store connector information including a pre-defined physical location of each of connectors 120 relative to the device (e.g., x-y parameters indicating location; general location parameters TOP-LEFT, TOP-RIGHT, BOTTOM-RIGHT, BOTTOM-LEFT) within memory 212. The pre-defined physical location of each of the connectors may be defined upon fabrication and/or programming of device 100 and/or connectors 120.

Device identification module 304 further maintains and/or updates device information including, for example, the type of connectors 120 and potential types of devices that can be coupled to each connector 120 (e.g., smartphone, peripheral devices, etc.) within memory 212. The relative physical location of each connector 120 is typically known with reference to the coordinate system associated with device 100 (e.g., extending in millimetres from a defined corner). Examples of connector information indicating relative location of connectors 120 is also shown in data store 312 of FIG. 4.

Additionally, in an embodiment, device information module 304 further includes device information, such as but not limited to: size of device 100 (e.g., 100 mm×200 mm), type of device (e.g., model), display 110 characteristics (e.g., pixel size, pixel colour depth, pitch, etc.) and other device information that may be used to derive spatial information. In another exemplary embodiment, device identification module 304 further includes information about the location of touch sensors on device 100 (e.g., relative to the device's coordinate system). The device information may be stored in memory 212. The location information of the touch sensors may be pre-defined (e.g., upon fabrication and/or programming of device 100) and stored within memory 212.

Thus, based on connector information provided by device identification module 304 (e.g., connector locations on the device), device type, device size, and touch screen information), connectivity module 302 can determine the relative spatial location of each of the other devices interconnected to mobile device 100. In the example configuration of FIG. 1, connectivity module 302 indicates, by way of the information in data store 312 shown in FIG. 4 that interconnected device 102 is located on the right side of device 100. By default, connectivity module 302 may assume that interconnected device 102 has the same characteristics, for example, device type, device size, touch display, as device 100. Additional information (e.g., device type, device size, and user interface or touch display information) can be provided by interconnected devices via communication module 306, and used by connectivity module 302 to further refine the determined relative spatial location of each of the other devices interconnected to mobile device 100 and for use by software applications of the devices for processing input/output display operations (e.g., determining merging of the multiple display screens for screen stitching).

Mobile device 100 may receive additional information on an interconnected device related to device size and/or display size of the interconnected device. For example, a device interconnected to mobile device 100 that is larger than device 100 may be interconnected with connectors 120B and 120C of device 100, which would initially allow deduction that the interconnected device is connected to the right of device 100. However, the additional information relating to device size may allow further refinements to the determined relative spatial location, for example, by indicating that device 102 extends in length beyond the length of device 100 and is perhaps centred upwards of display 110 of device 100. Additional information on an interconnected device may be stored in memory 212, for example, information indicating that the interconnected device extends beyond the length of device 100.

Communication module 306 is configured to establish a communication channel between device 100 and each interconnected device, using known techniques, for example, via communication subsystem and network interface 210, as described above.

Device 100 may further include a spatial relationship synthesizer module 308 stored in the memory 212. The synthesizer module 308 consolidates connectivity and other information received by one or more of modules 302, 304, and 306 to determine how to process input and output received on the device 100 relative to multiple input and output screens or touch displays provided by the interconnected device(s) (e.g., device 102) relative to the first device 100, this information can be useful for stitching together multiple displays (e.g., determining how to divide image data, for example an activation region 130, to span displays 110 on devices 100 and 102).

In one example, module 308 is configured to collect information regarding the location of displays on each device (e.g., device 100) and display parameters (e.g. resolution, pixel pitch, and display dimensions) in order to synthesize outputs onto multiple interconnected displays (e.g., displays 110 of device 100 and 102) and/or to process the inputs obtained via an interconnected display based on the display parameters and the location of the displays on each device 100, 102 and/or inputs obtained via each of the interconnected displays.

Other functionalities of the relationship synthesizer module 308 can include processing gestures across multiple devices or spanning an output display across a selected number of interconnected device displays, to allow rendering of graphics on a larger display surface.

In use, based on connectivity information, device 100 can determine the relative spatial location of one or more interconnected devices (e.g., device 102 is connected on the right side of device 100) as well as the relative spatial locations of user interfaces of one or more interconnected devices (e.g., touch displays 110 of device 100, 102).

As well, once devices 100 and 102 are interconnected with one another, devices 100 and 102 can communicate with one another and exchange information as needed over a communication channel established between the devices for example by way of a USB or other connection known to a person skilled in the art, between device 100 and 102.

In one embodiment, once two devices are proximate each other and a connection is established between respective connectors 120, 122 of devices 100, 102 and the relative spatial location of interconnected mobile device 102 is determined relative to mobile device 100, the spatial information may be stored in data store 312.

Activation region module 314 on device 100 may define an activation region 130 on a user interface, for example touch display 110 of device 100. As required, defining activation region 130 may be effected with aid of spatial information in data store 312 and information determined by spatial relationship synthesizer module 308, as discussed above. Activation region 130 may be visually indicated on touch display 110, as noted above and shown in FIG. 1.

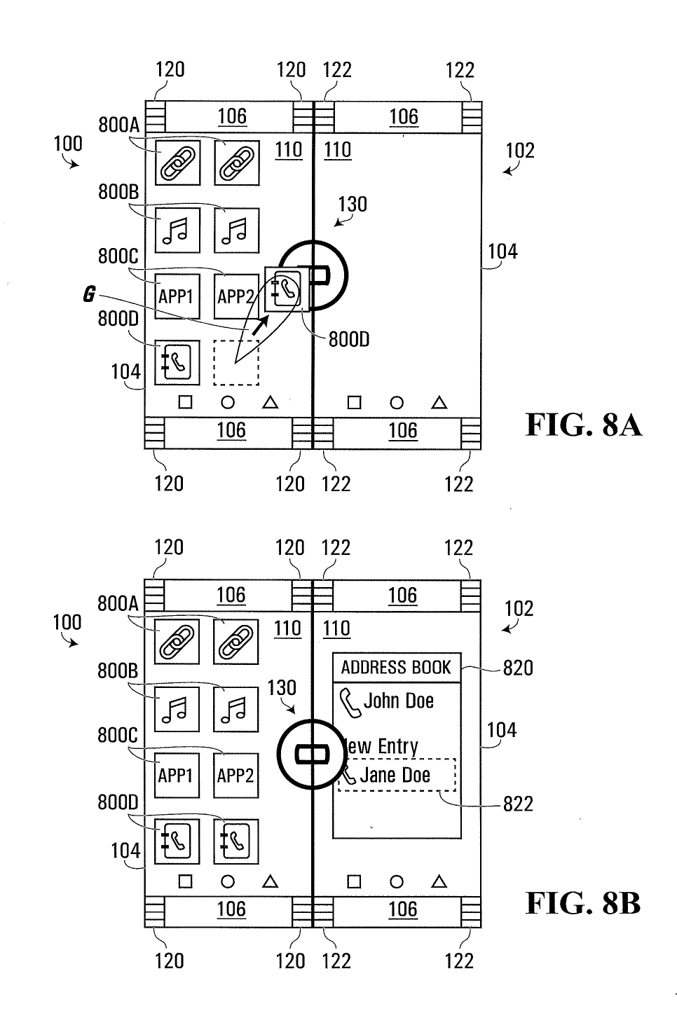

Activation region 130 may be operable by a user interaction to initiate cross-device communication such as a request for instructions to be performed on the interconnected device 102, for example, by dragging an icon to activation region 130, as further detailed below and illustrated in FIGS. 8A and 8B.

Cross-device communication can include, for example, sending or receiving requests to or from devices 100, 102, for example, to launch an application on another device, identify if an application is installed on another device and prompt for installation if necessary, play a music file, open a hyperlink, provide access to computing resources at one device to the other (e.g., memory, screen, speaker, or other computing and/or peripheral resources), stitch together displays 110 to create a larger display for rendering graphics (e.g., that allows device 100 to render graphics on the displays 110), send or receive data to or from devices 100, 102, etc.

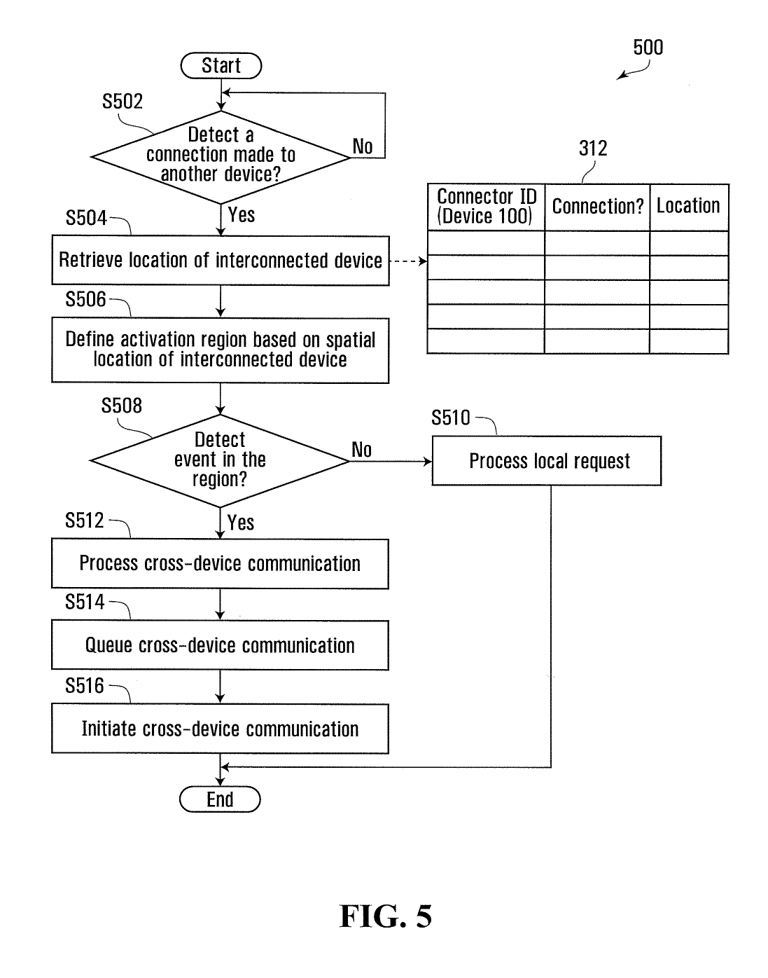

As illustrated in FIG. 5, cross-device communication may be initiated by device 100. Blocks 500 can be implemented by the modules 302, 304, 306, 308 and 314 and may operate on data store 312 and cross-device communication queue 316.

At block S502, device 100 may sense whether a connection has been made for one of connectors 120 with one or more interconnected devices (e.g., via the connectivity module 302), as detailed in PCT Publication No. WO 2015/070321. If a connection to an interconnected device is detected, device 100 proceeds to block S504.

At block S504, activation region module 314 at device 100 may retrieve spatial location data corresponding to interconnected device 102, as described above and detailed in PCT Publication No. WO 2015/070321.

At block S506, activation region module 314 at device 100 may adapt processor 202 of device 100 to assess the spatial location of device 102 based on the retrieved spatial location data corresponding to device 102. Activation region module 314 may then define activation region 130, corresponding to a particular region of touch display 110 of device 100, based on the spatial location data corresponding to device 102. A defined activation region indicates, visually or otherwise, that device 102 is interconnected.

More specifically, once the spatial location of device 102 is identified, activation region 130 may be defined to indicate, visually or otherwise, the relative physical location of interconnected device 102 that device 100 is capable of communicating with. The relative physical location of interconnected device 102 may be interpreted as device 102 being in contact with device 100 at a “border”—the “border” containing point or points of device 100 that can be defined by a coordinate or series of coordinates in the coordinate system of device 100. These coordinates may then be used to define the coordinates of a display edge, within the coordinate system of display 110, that is closest (amongst all of the edge boundaries of display 110) to the contacted portion of device 100. Such an edge may be identified and stored in memory as an “Edge ID”, as discussed below at block S514.

The coordinates of the display edge may then be used to define activation region 130. Activation region 130 may be defined by pixel coordinates in coordinate system of display 110. In the example shown in FIG. 1, activation region 130, comprising activation region 130A of device 100 and activation region 130B of device 102, encompasses a region of pixels that is vertically centred along the display edge proximate a border between devices 100, 102. The vertical location of activation region 130 may be aligned with a deduced vertical centre of interconnected device 102. The shape of the portion of activation region 130 on device 100, namely activation region 130A, may be formed as a semi-circle with a defined radius inwardly from the display edge. Other defined shapes for activation region 130 will be understood by a person skilled in the art.

In this way, activation region 130 may be defined as a region of pixels defined in the coordinate system of display 110 that is “proximate” a border between devices 100, 102, in that activation region 130 is closer to a border between devices 100, 102 (for example, edges of housing 104 of devices 100, 102 that are in contact) than other contact surfaces of housing 104 of device 100. Activation region 130 may be defined in some embodiments, on the basis of refined spatial location from additional information on interconnected device 102, which may be stored in memory 212 as previously discussed. For example, a border between device 100 and an interconnected device may be modified in the case of an interconnected device having a physical form factor that is a different size than device 100. For example, an interconnected device that is larger than device 100 may be interconnected with connectors 120B and 120C of device 100, allowing deduction, based on connector activity alone, that device 102 is connected to the right of device 100. However, further refinements to the spatial location, based on information that may be retrieved from memory 212, may indicate that device 102 extends in length beyond the length of device 100, and is perhaps centred upwards of display 110 of device 100. Therefore, activation region module 314 may adjust the definition of activation region 130 accordingly, for example, by moving or limiting activation region 130 to a further upwards or rightwards extent of the coordinate system of display 110.

In some embodiments, activation region 130 may be defined in part on the basis of the software applications or operations available on device 100, or as represented by icon, on display 110 of device 100.

As illustrated, device 100 may detect an event that may qualify as a request for cross-device communication in block S508. As will be appreciated, not all events detected at device 100 will be events indicating cross-device communication. Suitable event types that may, however, be identified as events that may initiate cross-device communication may be stored within memory 212.

Such suitable events may take any number of forms. For example, the event may be an input, for example an input gesture, at display 110 of device 100 having particular characteristics indicative of initiation of cross-device communication. For example, a suitable event may be an input at a particular input location on display 110 that corresponds, in the coordinate system of display 110, with the coordinates location of activation region 130, for example, a gesture originating or having a particular path crossing the coordinates of activation region 130 or ending at a location within the coordinates of activation region 130.

As noted, the event may be a gesture detected in block S508. For example, a swipe gesture may be detected as a detection of a touch caused by an implement such as a finger, stylus, or the like touching down on touch screen 110 of device 100. Such a gesture may continue, without lifting the implement, with the implement pulled across touch screen 110 in contact therewith, thereby tracing a path across touch screen 110 before being lifted off touch screen 110 at a second point. The lift off may also be part of the gesture—and detected. Processor(s) 202 may receive indications of all of these events such as, for example, over a bus from display 110. In some embodiments, multiple indications may be received or generated corresponding to each event. For example, a gesture may result in a series of touch events, each of which may be detected, and the collection of touch events, where appropriate, may be interpreted as a gesture. Multiple touch events may result in the generation of a message indicative of the gesture.

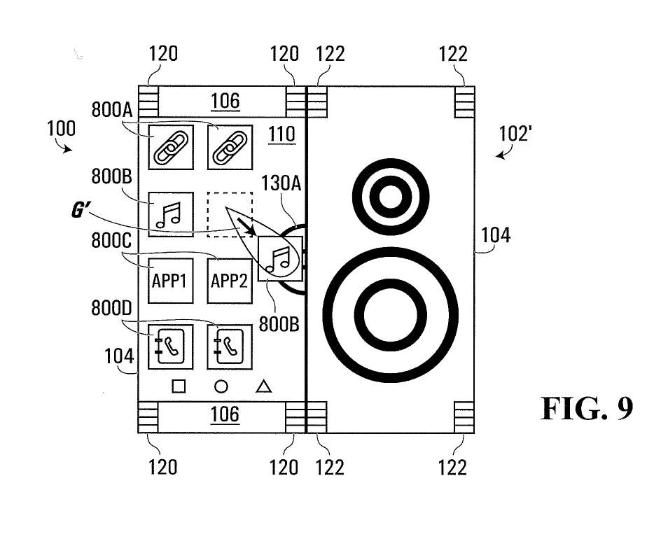

In some embodiments, a suitable event may be defined by a gesture that performs an action on device 100 by an input at display 110, for example, selecting an icon representing a resource or an application at device 100, and continually swiping across display 110, without lifting, until reaching a location on display 110 that corresponds, in the coordinate system of display 110, with the coordinates of activation region 130. Examples of such gestures are shown in the embodiments illustrated in FIGS. 8A, 8B and 9.

If device 100 does not detect (e.g., in block S508) a suitable event at activation region 130, then processing of the user input/gesture to initiate cross-device communication may terminate in block S508 onward. Optionally, device 100 may thereafter attempt to process the user input/gesture as a single-device input, local to device 100 at block S510, rather than across devices. Such processing may include interpreting the gesture as a single device gesture at device 100 and processing it accordingly, or notifying a user that suspected cross-device communication has been detected without interacting with activation region 130 as required or expected. For example, device 100 may treat a gesture that starts and results in lift off at device 100 proximate an edge of device 100 but not actually in activation region 130 as an event representative of a possible attempt at a request for cross-device communication in block S508.

If a suitable event is detected in activation region 130 in block S508, the cross-device communication request may be processed in block S512, to the extent required at device 100. The suitable event may prompt the generation of a cross-device communication. Such processing may determine the type of system resource indicated by the event, and generate a request for device 102 that is appropriate for or correlated to the resource type, for example. The desired cross-device communication may include granting access to a resource at device 100 to device 102 (e.g., memory, a peripheral (camera, speaker, etc.), etc.), requesting access to device 102, transferring a file from device 100 to device 102, transferring power from device 102 to device 100, transferring a signal for instructions to be executed by a processor at device 102, for example, to launch an application at device 102, and/or others as discussed above.

A cross-device communication may correspond to the suitable event that has prompted the cross-device communication. The suitable event may indicate a system resource based on the gesture path, and a cross-device communication may be generated that is appropriate for the resource type. For example, as illustrated in FIGS. 8A, 8B, a suitable event that involves selection of a contact may result in a cross-device communication that includes a signal for the interconnected device to launch an address book and add the particular contact to its address book.

Numerous other cross-device communications, as well as resource types which may prompt them, will be appreciated by those of ordinary skill.

Examples of types of resources and requests are described in more detail below. Requests may only be generated that device 102 is capable of satisfying, and an error message generated otherwise.

Furthermore, pairing may be performed at device 100 before the request is transmitted to device 102 at block S516. Devices 100, 102 may be paired to form an established communication channel. The communication channel may be provided as a USB compatible bus is established through the interconnected device connectors (e.g., connectors 120B and 122A), with, for example, device 100 serving as a USB host and device 102 serving as a USB slave, or other connection techniques as described above. As would be understood by a person skilled in the art, a communication channel may be established at other steps, as appropriate.

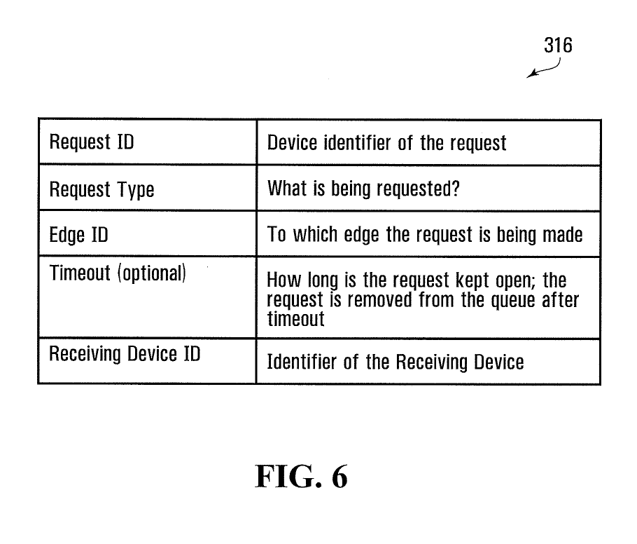

A record of the request may be stored at device 100 for retrieval by device 102 in block S514. To that end, device 100 may maintain a further data structure communication queue 316 which includes communication information that, reflecting each request for cross-device communication, for example, indicating data to be transferred. Communication queue 316 may, for example, have the form shown in FIG. 6. Other fields may be included in communication queue 316, as will be appreciated to those of ordinary skill.

Each record of cross-device communication may be stored in communication queue 316, each time block S514 is performed. Multiple requests may be queued for a given device 102, or multiple devices.

Alternatively, instead of queueing requests, device 100 may transmit (push) requests to the responding device (e.g., device 102) immediately, without queuing. This may be accomplished using an established communication channel, by communication module 306, between device 100 and device 102.

At block S516, cross-device communication is initiated, and the request is sent to device 102 over the established communication channel.

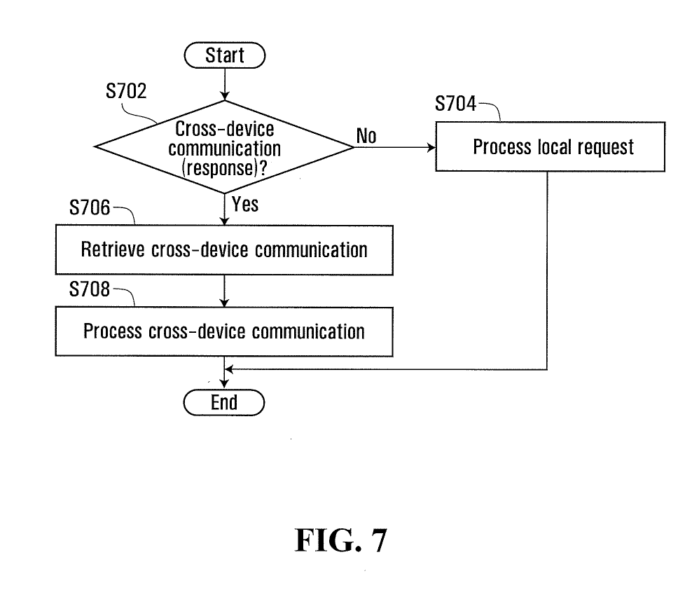

Steps performed under control of software at responding device 102 are illustrated in FIG. 7.

Device 102 may detect or impute cross-device communication in block S702. For example, a responding device, for example device 102, under software control may receive a message from an initiating device, for example device 100, indicative of a request for cross-device communication, originated for example in block S516 at device 100.

Alternatively, device 102 may also detect an event that may be used to deduce a request for cross-device communication, initiated at another device (e.g., device 100). Such an event typically follows a corresponding event at device 100. For example, the event at device 102 may be a second portion of an input gesture, detected at device 102. Such a cross-device gesture may be detected by detecting a gesture commencing (rather than ending) at device 100, and ending at device 102 proximate a border between devices 100, 102. For example, a gesture may originate outside of activation region 130A on device 100, and terminate or otherwise cross activation region 130B on device 102. For example, a user may begin a swipe gesture on device 100 and continue the gesture cross-device to terminate on device 102. In such a circumstance, device 102 may detect a connection to device 100, retrieve location of device 100, and define an activation region, in a similar manner to blocks S502, S504 and S506, respectively, as described above with reference to device 100.

Again, event types that may be identified as suitable events that correspond to cross-device communication initiated at another device may be stored within memory 212.

If responding device 102 detects an event, but determines that no request initiated at device 100, then responding device 102 may attempt to process the event (e.g., user input) as a single-device input at device 102 block S704 onward rather than a cross-device input.

If, however, the event is verified as a request for cross-device communication, in block S706, device 102 may retrieve any queued requests for device 102 from device 100. This may be accomplished using an established communication channel between device 100 and device 102, as described above.

Responding device 102 may further contact initiating device 100 in block S706 to determine if there are any additional requests queued for it, for example in communication queue 316.

Alternatively, queued requests may be pushed to responding device 102. Requests may be queued first in, first out, or in using any suitable queuing scheme.

Each request, as retrieved from the initiating device 100, may then be processed at the responding device 102 in block S708 and onward.

As will be appreciated, each device 100 and 102 may optionally act as both initiating device and responding device.

The above method may be useful for requesting actions across devices such as devices 100, 102.

FIG. 8A is a schematic block diagram of the pair of interconnected mobile computing devices of FIG. 1, generating a requested action. FIG. 8B is a schematic block diagram of the pair of interconnected mobile computing devices of FIG. 8A, illustrating the result of a responding device performing a requested action.

Touch display 110 of an initiating device, for example, device 100, may include icons representing various system resources, for example icons 800A representing web links, icons 800B representing music files, icons 800C representing applications, icons 800D representing phone contacts, etc. (collectively referred to as icons 800). Icons may also represent other resources as would be understood by a person skilled in the art.

A user may request actions at device 100 by activating any of icons 800, for example, by touching an icon 800 on display 110. For example, touching an icon 800A may cause a web browser application to launch at device 100 to open the link represented by the icon. Touching an icon 800B may cause a music player application to launch at device 100 to play the music file represented by the icon. Touching an icon 800C may cause the application represented by the icon to launch at device 100. Touching an icon 800D may cause device 100 to dial the contact represented by the icon.

In accordance with an embodiment of the method described above, a user may also request actions at device 102 by dragging any of icons 800 to activation region 130, and processed by device 100, for example, in the manner as described above with reference to block S508. Specifically, device 100 may detect a touch drag gesture that begins at a particular one of icons 800 and travels to activation region 130, for example, the part of activation region 130 on touch display 110 indicated by region 130A.

As shown in FIG. 8A, a user may input a gesture G extending from a position on touch display 110 of device 100 to activation region 130 proximate a border between device 102 and device 100. Gesture G represents an icon 800D being dragged to activation region 130 at device 100.

In some embodiments, device 100 determines the type of system resource represented by the icon, and then generates a request for device 102 that is appropriate for or correlated to the resource type, for example, in the manner as described above with reference to block S512. In the example illustrated in FIGS. 8A and 8B, upon determining that icon 800D represents a telephone contact, device 100 may generate a request for device 102 to add that particular telephone contact to its address book.

Device 100 may store the request in a communication queue 316 for retrieval by device 102, or may push the request to device 102, for example, as described above with reference to blocks S512, S514 and S516, and in the manners described in US Provisional Patent Application No. 62/332,215, the contents of which are hereby incorporated by reference.

As shown in FIG. 8B, at responding device 102 the request may be processed, for example, in the manner described above with reference to blocks S702 to S708 as shown in FIG. 7, resulting in a new entry 822 in application 820.

In some embodiments, an initiating device or responding device may not provide a visual representation of activation region 130 or have a visual display.

In some embodiments, a responding device may have no touch screen interface. In some embodiments, a receiving device may not have any user interface. In this case, a receiving device may periodically check for interconnected devices and poll interconnected devices for queued requests.

For example, as shown in FIG. 9, initiating device 100 may be a smartphone and a receiving device may be a peripheral device such as a speaker device 102′ that is capable of playback of music files. Speaker device 102′ may have connectors 120 that may be generally identical to connectors 120 of device 100. Icons 800B shown on touch display 110 of device 100 may represent, for example, a music file.

A user may input a gesture G′ extending from a position on touch display 110 of the smartphone (device 100) to activation region 130A proximate a border between speaker device 102′ and device 100, gesture G′ representing a request for speaker device 102′ to playback the music file represented by icon 800B, and processed by device 100, for example, in the manner described above with reference to blocks S508 to S516.

Device 100 may be configured to generate only those requests that device 102′ is capable of satisfying, for example, in the manner described above with reference to block S512. As such, device 100 may present an error message to the user upon detecting that icon 800A, 800C or 800D is dragged to activation region 130A.

In other examples, an icon 500C may be dragged to region 130 at device 100. Upon determining that the icon represents an application, device 100 may generate a request for device 102 to launch the particular application.

For such a request, device 100 may first identify all applications installed at device 102, for example, by querying device 102 or a centralized server storing this information. If device 100 determines that the application is installed at device 102 (or an equivalent, for example, and earlier or later version of the same application, or an application equivalent in functionality), then device 100 may generate a request for device 102 to launch the application installed on device 102. Alternatively, if the application (or an equivalent) is not installed at device 102, then the request may include a request to install the application from a remote server, or from device 100.

For example, if device 100 and device 102 are running an Android operating system, device 100 may request that device 102 install an Android application package (APK) stored at device 100, and then launch the application.

Optionally, device 100 may include in the request to device 102 user-specific application data (stored at device 100 or at a centralized server), including, for example, security credentials, user preferences for the application, etc.

Similarly, upon device 100 determining that an icon 800A representing a web link is dragged to activation region 130, device 100 may generate a request for device 102 to open the particular web link in a web browser.

Of course, the above described embodiments are intended to be illustrative only and in no way limiting. The described embodiments are susceptible to many modifications of form, arrangement of parts, details and order of operation. The disclosure is intended to encompass all such modification within its scope, as defined by the claims.

What is claimed is:

1. A mobile device comprising:
a processor;
a touch screen;
a plurality of connectors each for interconnecting the mobile device with at least one of a plurality of other devices, each of the plurality of connectors located in a defined location on the mobile device and configured to provide an indication detectable by the processor of when a connection to one of the other devices is made or lost; and
a memory storing processor executable instructions that when executed cause the processor to:
detect an interconnected device that is interconnected with the mobile device by way of at least one of the plurality of connectors;
establish a communication channel between the mobile device and the interconnected device;
determine a spatial location of the interconnected device relative to the mobile device, based on at least the defined location of the at least one of the plurality of connectors;
define a region on the touch screen of the mobile device in dependence upon the spatial location of the interconnected device, wherein the region is proximate a border between the touch screen of the mobile device and the interconnected device;
receive an input gesture on the touch screen of the mobile device; and
transmit a request to the interconnected device by way of the communication channel if a location of the input gesture corresponds at least in part to a location of the region on the touch screen.

2. The mobile device of claim 1, wherein the memory further stores processor executable instructions that when executed cause the processor to:
receive device information from the interconnected device, the device information comprising at least one of: size of the interconnected device, and physical location of respective connectors on the interconnected device that are connected to the mobile device; and
refining the determined spatial location of the interconnected device relative to the mobile device, in further dependence upon the device information.

3. The mobile device of claim 1, wherein the communication channel is established by way of the at least one of the plurality of connectors.

4. The mobile device of claim 1, wherein the memory further stores processor executable instructions that when executed cause the processor to queue the request in the memory.

5. The mobile device of claim 1, wherein the request comprises a signal for instructions to be executed by a processor in the interconnected device.

6. The mobile device of claim 1, wherein the request comprises data for transmission to the interconnected device.

7. The mobile device of claim 1, wherein the memory further stores processor executable instructions that when executed cause the processor to update the region on the touch screen to display visual attributes.

8. The mobile device of claim 7, wherein the visual attributes include an image indicating a position of the interconnected device.

9. The mobile device of claim 7, wherein the visual attributes include a visual indication of a contact point between the mobile device and the interconnected device.

10. The mobile device of claim 7, wherein the visual attributes include at least one of a defined color, and a visual indication of a boundary of the region.

11. The mobile device of claim 1, wherein the input gesture comprises dragging an icon displayed on the touch screen of the mobile device to the location of the region.

12. The mobile device of claim 11, wherein the request is correlated to a resource represented by the icon.

13. The mobile device of claim 1, wherein the request is correlated to a location of the touch screen where the input gesture originates.

14. The mobile device of claim 1, wherein the request is correlated to a location of the touch screen along a path of the input gesture.

15. The mobile device of claim 1, wherein the plurality of connectors comprise a magnetic connector.

16. The mobile device of claim 15, wherein the magnetic connector provides an electrical connection.

17. The mobile device of claim 1, wherein the memory further stores processor executable instructions that when executed cause the processor to:
receive, by way of the communication channel, data from the interconnected device when an input gesture is received at a location on the interconnected device corresponding at least in part to a region encompassing a point on a touch screen of the interconnected device that is proximate a border between the touch screen of the interconnected device and the mobile device.

18. A computer-implemented method of defining a region of a user interface for transmitting cross-device requests at a mobile device that comprises a processor, the user interface, and a plurality of connectors each for interconnecting the mobile device with at least one of a plurality of other devices, each of the plurality of connectors at a defined location on the mobile device and configured to provide an indication detectable by the processor of when a connection to one of the other devices is made or lost, said method comprising:
detecting, by the processor, an interconnected device that is interconnected with the mobile device by way of at least one of the plurality of connectors;
establishing, by the processor, a communication channel between the mobile device and the interconnected device;
determining, by the processor, a spatial location of the interconnected device relative to the mobile device, based on at least the defined location of the at least one of the plurality of connectors;
defining, by the processor, the region on the user interface of the mobile device in dependence upon the spatial location of the interconnected device, wherein the region is proximate a border between the touch screen of the mobile device and the interconnected device; and
transmitting, by the processor, a request to the interconnected device by way of the communication channel upon receiving an input gesture at a location corresponding at least in part to a location of the region on the touch screen.

19. The method of claim 18, wherein the communication channel is established by way of the at least one of the plurality of connectors.
